(19) United States
(12) Patent Application Publication
(10) Pub. No.: US 2009/0079225 A1
(43) Pub. Date: Mar. 26, 2009

(54) FUEL LID DRIVING APPARATUS

(75) Inventor: Kenji KATOU, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/206,940

(22) Filed: Sep. 9, 2008

(30) Foreign Application Priority Data
Sep. 24, 2007 (JP) 2007-246372

(51) Int. Cl. B60K 15/05

(52) U.S. Cl. 296/97.22; 220/211; 340/438; 701/49

(57) ABSTRACT

A fuel lid open-close mechanism includes a fuel lid open sensor for detecting an opening of a fuel lid, and the fuel lid is automatically closed by a fuel lid controller when the opening of the fuel lid is detected. The close operation of the fuel lid is performed when a predetermined condition of fuel lid closure absence is fulfilled. The fuel lid is closed by driving shutter members from an open position to a close position.

### CROSS REFERENCE TO RELATED APPLICATION

The present application is based on and claims the benefit of priority of Japanese Patent Application No. 2007-246372 filed on Sep. 24, 2007, the disclosure of which is incorporated herein by reference.

### FIELD OF THE INVENTION

The present disclosure generally relates to a fuel lid driving apparatus for use in a vehicle.

### BACKGROUND INFORMATION

The fuel lid driving mechanism recently proposed in, for example, Japanese patent documents JP-A-H06-206457 (U.S. Pat. No. 5,533,766), JP-A-2006-299994, JP-A-2001-1770 (U.S. Pat. No. 6,234,557), and JP-A-H08-163654 drives open and close a fuel hole by operating shutter member with a motor disposed closely to the fuel hole as the alternative of a manually-driven cap or the like. Various reasons and background are stated in those documents including a prevention of hand contamination due to a handling of a lid of a tank as well as a prevention of a loss of the lid, a reduction of fueling operation by enabling an opening and closing of the fuel hole without getting off a vehicle, and a secured operation of fuel hole opening in an automated gas station that automatically fuels the vehicle.

However, all of the above disclosures lead to a solution of a self-explanatory subject of labor-saving in fueling work by employing a driving mechanism for opening and closing the fuel hole. Specifically, the method disclosed in the document JP-A-H08-163654 requires an auto-fueling facility in gas stations, thereby leading to an enormous cost due to an introduction of labor-saving infrastructure outside of a vehicle. In recent years, however, the gas stations are gradually converted to a self-serve type, and an incentive to introducing the auto-fueling facility for attracting customer's attention may be decreasing based on a hike of the crude oil price.

Further, fueling work in the gas station may be mainly performed by lay drivers, thereby leading to an anxiety of causing an elementary error such as absence of fuel lid closure after the completion of fueling due to absentmindedness or the like. The technique disclosed in the above disclosures does not pay any attention to the technical background caused by a transition to the self-serve method, thereby providing no effective measure to prevent such absence of fuel lid closure after the completion of fueling.

### SUMMARY OF THE INVENTION

In view of the above and other problems, the present disclosure, as an aspect of the invention, provides a fuel lid driving apparatus that securely prevents absence of fuel lid closure due to absentmindedness after completion of fueling at a self-serve type gas station or the like.

The fuel lid driving apparatus in a vehicle includes: a fuel lid movable between a close position that closes a fuel hole and an open position that opens the fuel hole; a fuel lid driver for driving the fuel lid between the close position and the open position; a fuel hole condition detector for detecting an open condition and a close condition of the fuel hole; a situation determiner for determining whether or not an absence of a fuel lid closure is due to absentmindedness when the open condition of the fuel hole is detected; and a fuel lid controller for controlling the fuel lid driver to drive the fuel lid to the close position when the situation is determined to result from absentmindedness.

The configuration of the fuel lid driving apparatus described above securely prevents the absence of the fuel lid closure after the completion of fueling at a self-serve type gas station or the like. More practically, the apparatus automatically closes the fuel hole by having a fuel hole condition detector for detecting an open/close condition of the fuel hole and by using a fuel lid controller. In that case, whether a predetermined condition of fuel hole closure absence due to absentmindedness is fulfilled is determined, and, when the condition is determined to be fulfilled, shutter members at an open position are driven to a close position. That is, by providing the situation determiner, the situation of fueling is correctly determined for the exclusion of fuel lid suitably opening cases such as fuel lid opening due to a start of fueling, a continuation of fueling or the like, and to selectively performing a fuel hole closure operation only for the fuel hole opening due to the absentmindedness of a fueling person.

### BRIEF DESCRIPTION OF THE DRAWINGS

Other objects, features and advantages of the present invention will become more apparent from the following detailed description made with reference to the accompanying drawings, in which:

FIG. 1 shows a block diagram showing an example of an electric configuration of a smart entry system which uses a fuel lid opening and closing mechanism in an embodiment of the present invention;

FIG. 2 shows an illustration of an outer detection area and an inner detection area in and around a vehicle;

FIGS. 3A and 3B show illustrations of a nozzle sensor disposed on the vehicle;

FIGS. 4A to 4C show illustrations of operations of the fuel lid opening and closing mechanism in terms of opening a fuel lid;

FIG. 5 shows an illustration of an operation of the fuel lid opening and closing mechanism in terms of closing the fuel lid;

FIGS. 6A and 6B show two other illustrations of operations of the fuel lid opening and closing mechanism in terms of closing the fuel lid;

FIGS. 7A to 7E show illustrations of operations of shutter members for opening and closing the fuel lid; and

FIG. 8 shows a flow chart of a process of the fuel lid opening and closing mechanism.

### DETAILED DESCRIPTION

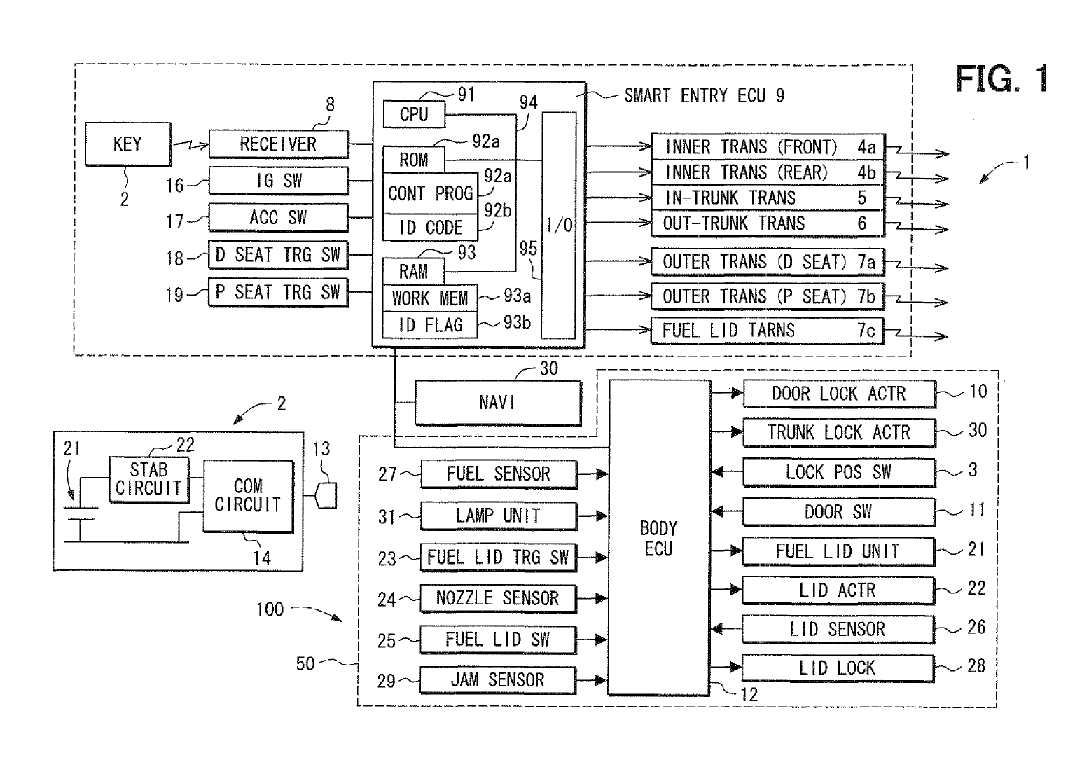

An embodiment of the present invention is explained next while referring to the drawing. FIG. 1 is a block diagram showing electric configuration of a fuel lid opening and shutting mechanism 100 in one embodiment of the present invention. In the essential part of the fuel lid opening and shutting mechanism 100, it is mainly constituted from a so-called smart entry system (a wireless lock system) 1 connected through a communication line and a body control unit 50. The subject of controlling of the smart entry system 1 is a smart entry ECU 9, and the other parts such as a receiver 8 (authentication information reception means), in-vehicle transmitters 4a, 4b, a in-trunk transmitter 5, a trunk outside transmitter 6, a compartment outside D seat transmitter 7a, a compartment outside P seat transmitter 7b receiving a radio signal from a portable key 2 having wireless communication function and a fuel lid transmitter 7c are connected thereto. In addition, an IG SW (ignition switch) 16, an ACC (accessories) SW 17, a D seat trigger SW 18, a P seat trigger SW 19 are connected to the smart entry ECU 9. Each of the trigger switches 18, 19 is a touch sensor disposed on a door outside handle (not illustrated) to open and close a door.

On the other hand, the controlling subject of the body control unit 50 is a body ECU 12, and other parts such as door lock actuators 10 on each of the doors, a trunk lock actuator 30, a lock position SW 3, a courtesy lamp SW 11 on each of the doors, a hazard lamp unit 31, a trigger switch 23, a nozzle detection sensor 24 (i.e., a nozzle detector in claiming language), a fuel lid open switch 25, a fuel lid drive unit 21, a fuel lid actuator 22, a fuel lid sensor 26, a fuel lid lock unit 28, and a jam sensor 29 are connected thereto.

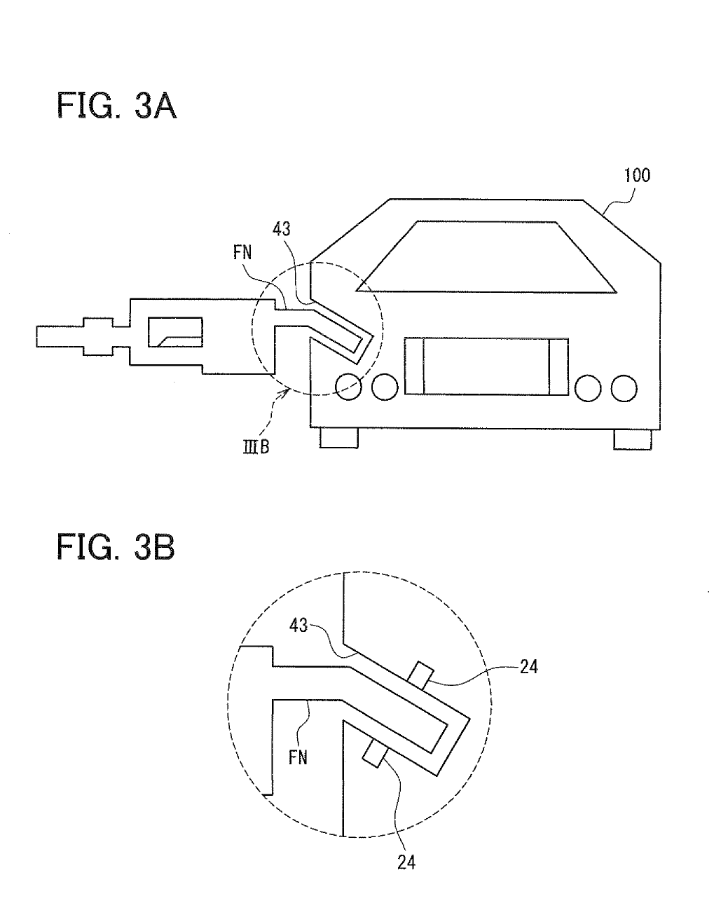

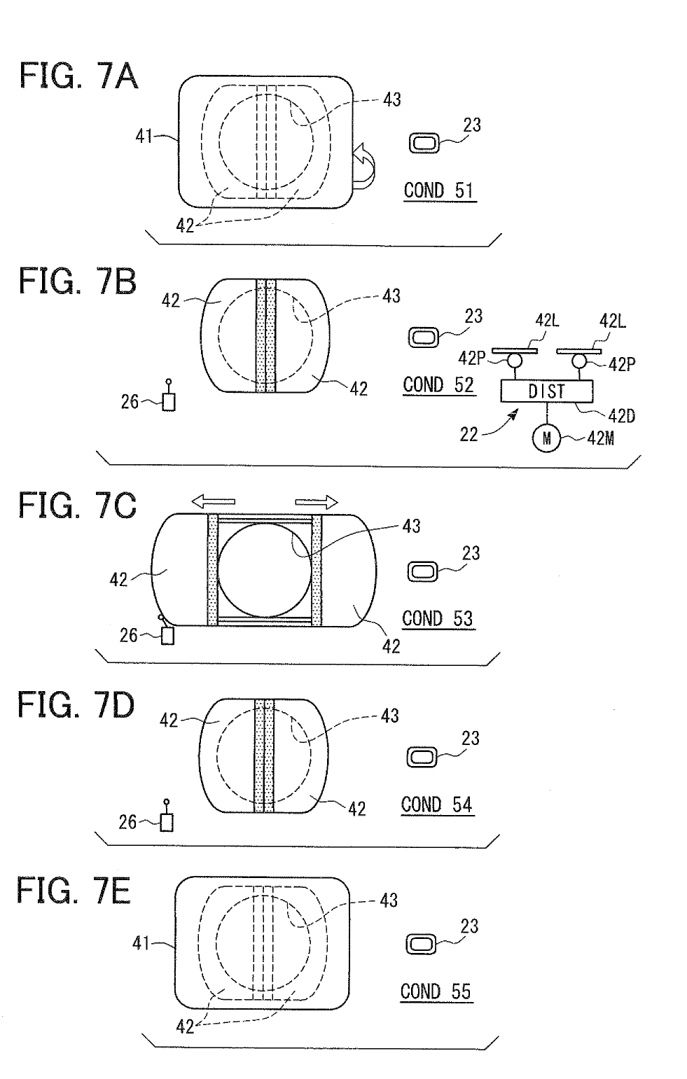

The nozzle detection sensor 24 includes, as shown in FIG. 3B, a transparent type optical sensor, a reflecting type optical sensor, and a proximity switch installed in an inside of a fill opening 43 (i.e., a fuel hole), and the sensor 24 detects whether or not a refueling nozzle FN is inserted in the fill opening 43. The fuel lid open switch 25 is disposed near the driver's seat at a driver's foot portion or the like, and the body ECU 12 outputs a trigger signal for opening the fuel lid 41 that covers the fill opening 43 (i.e., a condition 51 in FIG. 7A) by the fuel lid drive unit 21. In this case, the fuel lid drive unit 21 may only mechanically transfer a manual operation on the fuel lid open switch 25 to the fuel lid without performing an electronic drive control under control of the body ECU 12.

The fuel lid actuator 22 is used to replace a conventional cap of the fill opening 43 with a shutting/opening mechanism, and includes, as shown in a condition 52 of FIG. 7B, a pair of shutter members 42, 42 at a covering position of the fill opening 43 and a driving motor 42M as main components. The rotatory power of the drive motor 42M is distributed and transferred to racks 42L, 42L on each of the shutter members 42, 42 through a distributor 42D and pinion gears 42p, 42p. The directions of the rotation of the pinion gears 42p, 42p are mutually opposite. Therefore, the shutter members 42, 42 respectively slide to an open position when the motor 42M rotates in a normal direction, and respectively slide back to a close position when the motor 42M rotates in a reverse direction. Further, the fuel lid sensor 26 corresponds to a condition detector in claiming language, and detects the shutter member 42 slid to the open position (conditions 52, 53 in FIG. 7B, 7C) by employing a well-known limit switch, a proximity switch or the like. The fuel lid lock unit 28 prevents the sliding movement of the shutter members 42 in a well-known manner, and provides an interlock control for prohibiting the operation of the fuel lid actuator 22 when the lock unit 28 is in a locked condition. Further, a jam sensor 29 is a touch sensor or the like at an inner periphery of the shutter members 42, 42, and detects a jam of foreign matter or the like in between the shutter members 42, 42.

The smart entry ECU 9 uses microcomputer hardware as its main component, and includes a CPU 91, a ROM 92, a RAM 93 and an input and output unit (I/O) 95 mutually connected through a bus line 94. The I/O 95 of the ECU 9 has a connection to the receiver 8, the IG SW 16, the ACC SW 17, the D seat trigger SW 18 and the P seat trigger SW 19. A control program 92a and an identification code 92b for the authentication are memorized in the ROM 92, and a work memory 93a as an execution area of the control program 92a as well as an ID authentication flag 93b to show an authentication result (acceptance/rejection) are formed in the RAM 93. In addition, the portable key 2 has a built-in battery 21 that provides operation power, a stabilizing circuit 22 for stabilizing the battery power output, a communication circuit 14 and an antenna 13. In the communication circuit 14, the identification code that is peculiar to each vehicle is memorized.

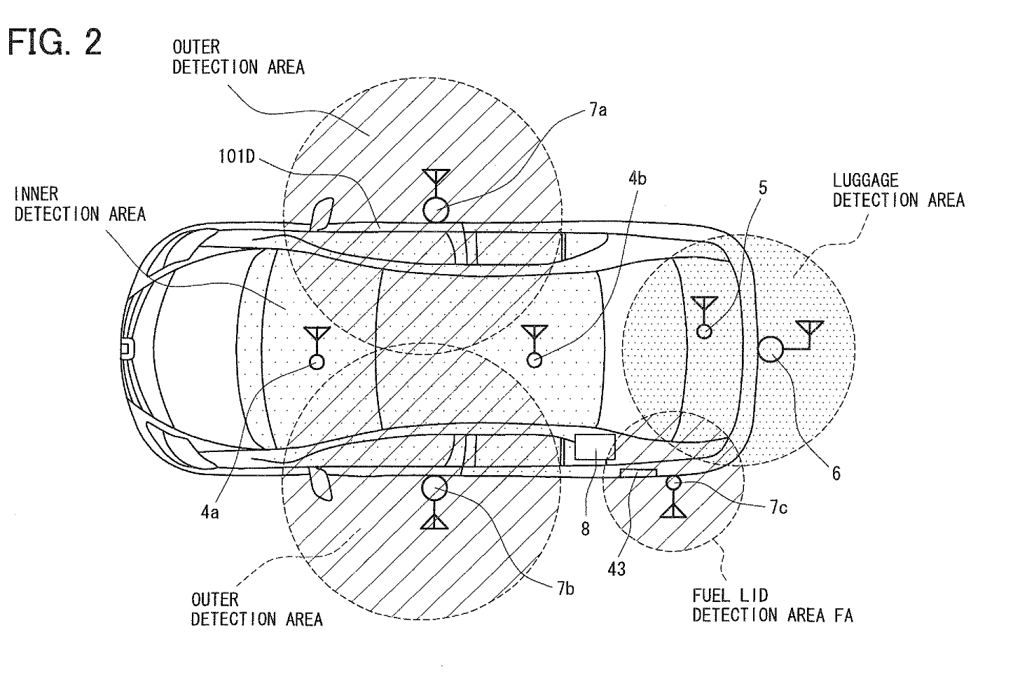

FIG. 2 shows an example of the installation position of each of the transmitters on a vehicle (e.g., an automobile). In other words, the D seat transmitter 7a outside of the compartment is disposed on a driver's seat side door, and the P seat transmitter 7b outside of the compartment is disposed on a passenger seat side door. In addition, the in-vehicle transmitters 4a, 4b are disposed in a front part and a rear part in the inside of the vehicle, and the in-trunk transmitter 5 and the trunk outside transmitter 6 are disposed around the trunk. Furthermore, the fuel lid transmitter 7c is disposed at a position that is next to the fill opening 43 on a side surface of the body of the vehicle on a rear part so that a radio coverage area FA is formed around the fill opening 43 outside of the vehicle. The fuel lid transmitter 7c is equivalent to a radio wave transmitter in claiming language.

Because it is well-known about the basic operation of the smart entry system, an outline of the basic operation is described by using a concrete example (the described operation is realized through the execution of the control program 92a by the smart entry ECU 9 as well as the execution of the control program (not shown in the drawing) by the body ECU 12 under instructions from the smart entry ECU 9 through the communication line (also not illustrated)). At first, when a polling electric wave is sent to the outside of the vehicle regularly by the transmitters 7a, 7b by a user who is not in the inside of the vehicle (i.e., outside polling), and, when the user possessing the portable key 2 approaches a detection area mentioned later, the portable key 2 receives the radio signal of polling, and the portable key 2 sends back an ID code. The ECU 9 compares the ID code with the identification code 92b memorized in the ROM 92, and performs an authentication (the authentication result is memorized by using the ID authentication flag 93b). When the authentication is accepted, either the actuator 10 is operated to unlock the door, or the door is put in an unlocking operation wait state that the unlocking of the door is possible by the operation of the user from the outside of the vehicle, After the door is put in the unlocking operation wait state, the door is unlocked when, for example, the user touches the D seat trigger SW 18 (i.e., a touch sensor on the door handle), and the door is locked again when the user touches the trigger SW 18 again or when the user possessing the portable key 2 leaves the detection area outside of the vehicle.

When the driver's seat door 24 is unlocked, the transmission of the polling electric wave to an inside of the compartment is started by the in-vehicle transmitters 4a, 4b (i.e., inside polling). If the user having the portable key 2 is in the inside of the vehicle, the portable key 2 responds to a polling electric wave in the compartment, and the authentication by the identification code is performed likewise. If the authentication is accepted, the starting of the engine is made possible by turning on the IG SW 16. The transmission of the polling electric wave in the compartment is repeated regularly, and the response from the portable key 2 to the polling in the compartment is terminated when the user opens a door and goes out to the outside of the vehicle. At this point, if the last authentication result by the polling in the compartment is the acceptance, the door is put in a locking wait state, and the outside polling is restarted with the inside polling being stopped. Then, the door is locked when the user touches the D seat trigger SW 18 in the above described state or when the user possessing the portable key 2 leaves the detection area outside of the vehicle (in other words, when the portable key 2 does not respond to the outside polling).

In addition, when the user opens the door to go out of the vehicle, the purpose of the user's action may be a refueling in a gas station or the like. If the driver's seat door opens after the IG SW 18 is turned off, the transmission of the polling electric wave is restarted by the fuel lid transmitter 7c.

Each of the functions regarding the fuel lid opening and shutting mechanism 100 in the present invention is realized through the execution of the control program 92a by the smart entry ECU 9 and the execution of the control program in the body ECU 12 under the instructions from the smart entry ECU 9 through the communication line. The functions of the mechanism 100 includes:
an absence detector (the smart entry ECU 9): determines fulfillment of a fuel lid closure absence condition when the fuel lid is detected as being open.

a fuel lid controller (the body ECU 12)
a key search unit (the smart entry ECU 9)
an authentication unit (the smart entry ECU 9)
a fueling completion detector (the body ECU 12)
a fuel lid open condition determiner (the smart entry ECU 9)
a fuel lid open permission provider (the smart entry ECU 9)

Each of the functions described above as a functional component is described in detail function by function in the following description.

The absence detector determines the fulfillment of the fuel lid closure absence condition in the following sequence of conditions (1) to (4). That is, when the following sequence of conditions is fulfilled in the described order, fulfillment of the fuel lid closure absence condition that defines a situation that the fuel lid is left open inadvertently by absentmindedness of a user is determined That is,

(1) After the detection of the fill opening 43 by the fuel lid sensor 26, use of the refueling nozzle FN (shown in FIG. 3A) is detected by the nozzle detection sensor 24.

(2) The portable key 2 is detected in the radio coverage area HA (shown in FIG. 2) by the fuel lid transmitter 7c.

(3) Further, use of the refueling nozzle FN detected by the nozzle detection sensor 24 shifts to a non-use condition of the nozzle FN.

(4) Then, the portable key 2 in the radio coverage area FA shifts to a non-detection state with the fill opening 43 being kept as open.

In other words, the absence detector uses the following points as required conditions. That is,
the detected fuel lid condition is “open,” and the portable key 2 is searched for once in the radio coverage area FA and is found with the authentication result indicating the acceptance of the authentication, then the portable key search in the area HA turns to a no-key in the area FA condition or turns to authentication rejection with the fuel lid identified as being left open, and
use of the nozzle is not detected by the nozzle detection sensor 24.

The fuel lid controller (the body ECU 12) operates the fuel lid actuator 22 to move the shutter members 42, 42 to the close position from the open position when the fuel lid closure absence condition is fulfilled.
a key search unit (the smart entry ECU 9): Based on response signal information from the portable key 2 in response to an electric wave of polling, the unit detects whether the portable key 2 exists in the radio coverage area FA around the fill opening 43.
an authentication unit (the smart entry ECU 9): Based on the received authentication information, the unit authenticates the portable key 2.
a fueling completion detector (the body ECU 12): Based on the detected residue amount of fuel from the fuel residual quantity sensor 27, the unit determines completion of refueling. That is, the unit determines that the refueling is completed when the increase of the fuel residual quantity stops at a certain quantity for a predetermined period after a start of the increase of the fuel residual quantity. This unit may be omitted.
a fuel lid open condition determiner (the smart entry ECU 9): When the fuel lid is detected to be closed, fulfillment of the fuel lid open condition for allowing opening of the fuel lid is determined by the unit.
a fuel lid open permission provider (the smart entry ECU 9): When the fuel lid open condition is fulfilled, the provider permits the fuel lid actuator 22 to drive the shutter members 42, 42 to the open position.

More practically, when the required conditions that, (1) the fuel lid is closed, (2) the portable key 2 is searched in the radio coverage area FA, and (3) the authentication of the key 2 is accepted, are fulfilled, the fuel lid open condition is determined to be fulfilled. Then, upon seeing the fulfillment of the fuel lid open condition, the shutter members 42, 42 are driven to the open position by the operation of the trigger switch 23, In addition, when the fuel lid open condition is fulfilled, the shutter members 42, 42 may automatically be opened, and, at the same time, the trigger switch 23 may be omitted. In addition, the fuel lid open condition is determined to be fulfilled only when the current location of the vehicle according to the navigation system 30 of FIG. 1 is in the gasoline supply facility. Therefore, the shutter members 42, 42, are not driven open when the vehicle is outside of the gasoline supply facility. However, at a time of emergency, opening of the shutter members 42, 42 may be enabled by an operation of a specific switch in the compartment of the vehicle.

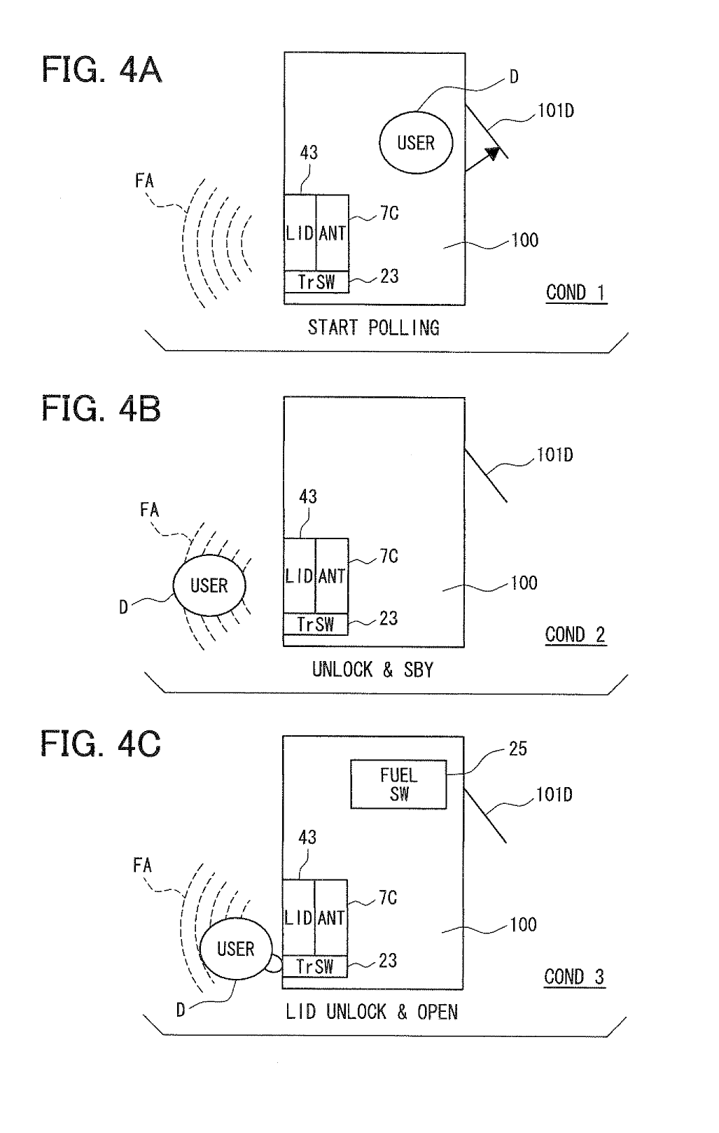

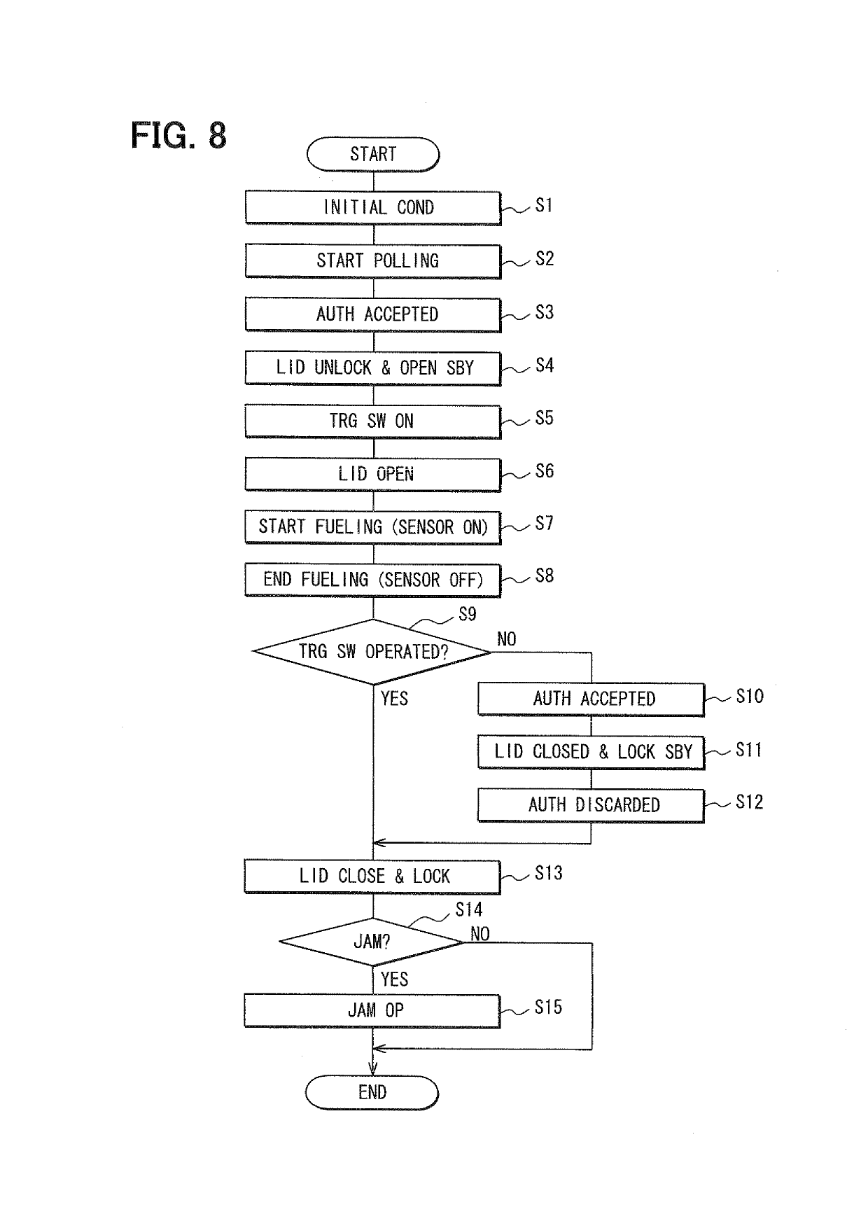

A processing flow of the fuel lid opening and shutting mechanism 100 is described in detailed with reference to a flow chart in FIG. 8. At first, the process confirms, in St, whether or not the vehicle is stopping in the refueling facility (e.g., a gas station), and upon determining the stopping, the process confirms whether or not the IG SW 18 is turned from ON to OFF, and further determines whether or not the driver's seat side door has shifted from a close state to an open state. Upon determining the fulfillment of all of the above conditions, the process proceeds to S2, and the polling signal is transmitted from the transmitter 7c toward the radio coverage area FA (FIG. 2) as shown in a condition 1 in FIG. 4A. In this case, because the fuel lid 41 is closed as shown in the condition 51 in FIG. 7A, the user opens the fuel lid 41 as shown in the condition 52 in FIG. 7B by operating the fuel lid open switch 25 before getting off from the vehicle. Further, the trigger switch 23 is disposed next to the fuel lid 41.

If there is a response from the portable key 2 to the polling signal as shown in the condition 2 in FIG. 4B, the process proceeds to 53, and the process authenticates the ID code that has been sent. If it is authenticated, the process proceeds to S4, and the locked condition of the shutter members 42, 42 by the lock unit 28 is released (fuel lid unlocking), and the actuator 22 is put in a standby condition for opening the fill opening 43. (If the portable key 2 does not respond, or the authentication is rejected after the response, the transition to the standby condition is prohibited.)

The shutter members 42, 42 are driven to the open position as shown in a condition 53 in FIG. 7C by the actuator 22 (also mentioned in S6 in FIG. 8) when the trigger switch 23 is operated (illustrated in FIG. 4C and in S5 of FIG. 8). At this time, the shutter members 42, 42 bias the fuel lid sensor 26, and the opening of the fill opening 43 is detected (mentioned in S7 in FIG. 8). Therefore, as shown in FIG. 3A, the refueling is made possible when the nozzle FN is put into the fill opening 43. In most cases, the fuel pump in the gas station has a fuel sensor in the nozzle FN for automatically stopping the refueling when the fuel is fully poured into the fuel tank. Therefore, the user D may leave the position of the fill opening 43 once he/she has started the refueling. Then, the portable key 2 carried by the user D goes out of the coverage area FA, and the response to the polling is lost, thereby disabling the authentication for the ID code.

On the other hand, as the refueling proceeds, the increase of the fuel residual quantity stops when supply of the fuel from the nozzle FN stops. When a fuel residual quantity increase stop period reaches a predetermined time, e.g., 10 seconds, and the nozzle sensor 24 indicates the non-detection condition, that is, when the nozzle FN is pulled out of the fill opening 43 (mentioned in S8 in FIG. 8), the body ECU 12 determines that the refueling has completed, and transmits the completion information to the smart entry ECU 9. In this case, if the fill opening 43 is opened up without refueling being performed, the smart entry ECU 9 does not notify the body ECU 12 of the completion of refueling because the fuel residual quantity does not change.

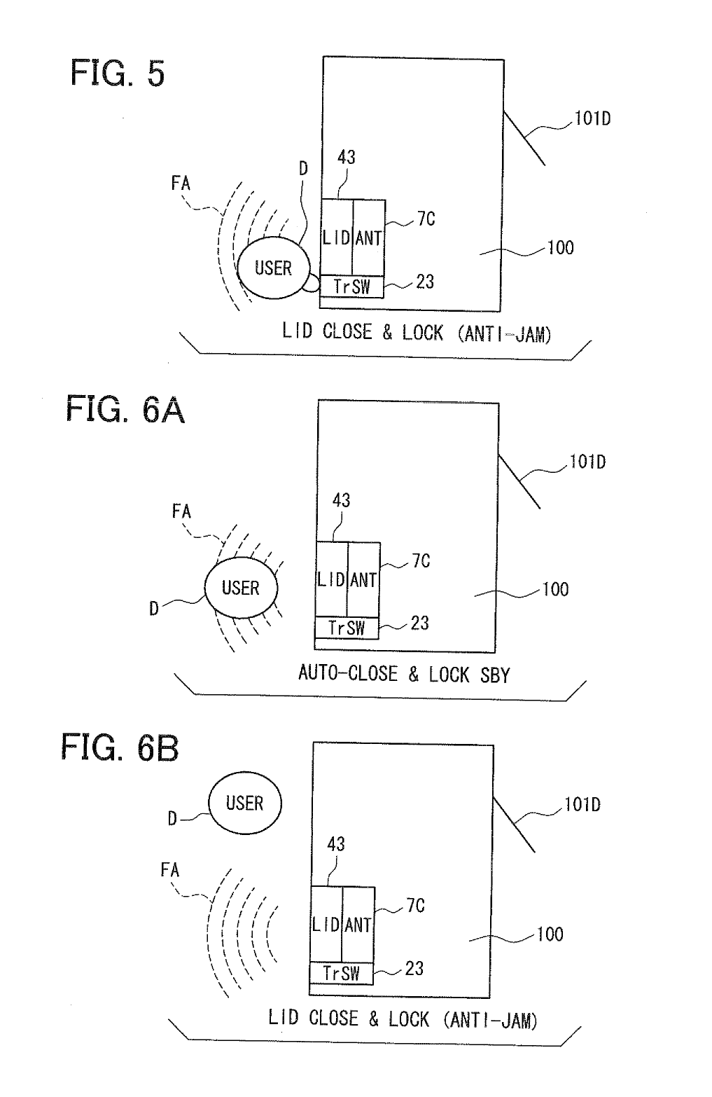

The user D returns to the position of the fill opening 43 with the portable key 2 when the refueling completes. Then, the process confirms whether the trigger switch 23 is operated in S9 of FIG. 8. When the trigger switch 23 is operated as shown in FIG. 5, the shutter members 42, 42 are moved to the close position regardless of the response from the portable key 2 (or, regardless of the authentication result) as long as the non-detection condition is reported from the nozzle detection sensor 24, and the lock unit 28 is put in the locked condition (S13 in FIG. 8). In other words, a service man in the gas station or the like can open/close the fill opening 43 by manually operating the trigger switch 23 without having the portable key 2.

Because the user D always returns to the radio coverage area FA for pulling out the nozzle FN as shown in FIG. 6A, the process proceeds to S10 in FIG. 8 to confirm the returning through the response from the portable key 2. When the authentication is accepted and the completion of the refueling has been notified, the smart entry ECU 9 puts the fill opening 43 in the standby condition for automatic closure and locking operation (mentioned in 511 in FIG. 8). On the other hand, when the user D self-fuels the vehicle at the self service gas station or the like, the user D may inadvertently return to the driver's seat without operating the trigger switch 23 to close the fill opening 43 (i.e., the absence of the trigger switch operation). In this case, the process proceeds to S13 in FIG. 8 to automatically drive the shutter members 42, 42 to the close position, and the lock unit 28 is put in the locked condition (shown in FIG. 6B and as a condition 54 in FIG. 7D), because the response to the polling disappears and the authentication by the ID code comparison turns to be rejected (mentioned in S12 in FIG. 8).

As a result, the fuel lid 41 (FIG. 7C) is inadvertently left in the opened condition, a warning mechanism such as a beep or a display as well as an automatic fuel lid close mechanism may be provided for closing the fuel lid as shown in a condition 55 of FIG. 7E.

Although the present invention has been fully described in connection with the preferred embodiment thereof with reference to the accompanying drawings, it is to be noted that various changes and modifications will become apparent to those skilled in the art.

For example, the above processing can be simplified in the following manner. For example, the shutter members 42, 42 may automatically be driven to the close position without checking a response from the portable key 2 and the key authentication result if the nozzle FN is pulled out from the fill opening 43 and the nozzle detection sensor 24 reports a non-detection condition. In particular, checking the response from the portable key 2 and the authentication result may not be required when the shutter members 42, 42 is configured to be only manually driven by the operation on the trigger switch 23. That is, in the above configuration, the shutter members 42, 42 may be closed either by the operation of the trigger switch 23 or by referring to the detection result of the nozzle sensor 24. (Therefore, the omission of the fuel lid transmitter 7c is possible).

If the driving of the shutter members 42, 42 to the close position is started in S13, the process proceeds to S14, and the jam sensor 25 (FIG. 1) is used to check whether or not any object is jamming. If jamming is not detected, the processing is finished. If the jamming is detected, the process proceeds to S15, and the shutter members 42, 42 are returned to the open position (i.e., JAM operation).

In addition, the fuel lid transmitter 7c may be omitted when the coverage area of the transmitter 7a/7b can be expanded to include the fill opening 43, and when a function of the fuel lid transmitter 7c mentioned above can be replaced with the transmitter 7a/7b. Further the fuel lid closure absence condition may be determined based on the response to the polling from the in-vehicle transmitters 4a/4b instead of the loss of the response to the polling in the area FA around the fuel lid (that is, the returning of the user D to the driver's seat inadvertently without closing the fuel lid may be detected).

Such changes and modifications are to be understood as being within the scope of the present invention as defined by the appended claims.

What is claimed is:

1. A fuel lid driving apparatus in a vehicle comprising:
a fuel lid movable between a close position that closes a fuel hole and an open position that opens the fuel hole;
a fuel lid driver for driving the fuel lid between the close position and the open position;
a fuel hole condition detector for detecting an open condition and a close condition of the fuel hole;
a situation determiner for determining whether or not an absence of a fuel lid closure is due to absentmindedness when the open condition of the fuel hole is detected; and
a fuel lid controller for controlling the fuel lid driver to drive the fuel lid to the close position when the situation is determined to result from absentmindedness.

2. The fuel lid driving apparatus of claim 1, wherein
a wireless key system is disposed in the vehicle,
a radio wave transmitter for transmitting a key polling wave in a polling area that exists at a proximity of the fuel lid is provided in the vehicle,
a key detector for detecting a wireless key in the polling area based on response information is provided in the vehicle, and
the situation determiner performs a determination when both of a first condition that the fuel lid is open and a second condition that the wireless key is not detected in the polling area are respectively fulfilled as prerequisites.

3. The fuel lid driving apparatus of claim 2 further comprising:
an information receiver for receiving authentication information from the wireless key in the polling area; and
an authentication unit for authenticating the wireless key based on the received authentication information, wherein
the situation determiner performs a determination when both of the first condition that the fuel lid is open and a third condition that the wireless key is detected and authenticated in the polling area to turn to be one of un-detected in the polling area and un-authenticated with the first condition being maintained are respectively fulfilled as prerequisites.

4. The fuel lid driving apparatus of claim 1 further comprising:
a nozzle detector for detecting a fuel nozzle being put in the fuel hole, wherein
the situation determiner performs a determination when both of the first condition that the fuel lid is open and a fourth condition that the fuel nozzle is not detected by the nozzle detector are respectively fulfilled as prerequisites.

5. The fuel lid driving apparatus of claim 4 further comprising:
a residue detector for detecting a residue amount of fuel in the vehicle, and
a fueling end detector for detecting an end of fueling based on the residue amount of the fuel detected by the residue detector, wherein
the situation determiner performs a determination when both of a first condition that the fuel lid is open and a fifth condition that the end of fueling is detected are respectively fulfilled as prerequisites.

6. The fuel lid driving apparatus of claim 1 further comprising:
a trigger switch for manually generating a trigger signal with regard to an open and close drive of the fuel lid, wherein the trigger switch is disposed next to the fuel hole and to be operable from an outside of the vehicle, wherein
the fuel lid is driven to the close position by the situation determiner without regard to whether or not the absence of the fuel lid closure is due to absentmindedness.

7. The fuel lid driving apparatus of claim 1 further comprising:
an open situation determiner for determining whether or not opening of the fuel lid is permissible when the fuel lid is detected to be in the close condition; and
an open drive controller for permitting the fuel lid driver to drive the fuel lid from the close position to the open position when the opening of the fuel lid is determined to be permissible.

8. The fuel lid driving apparatus of claim 7 further comprising:
a trigger switch for manually generating a trigger signal with regard to an open and close drive of the fuel lid, wherein the trigger switch is disposed next to the fuel hole and to be operable from an outside of the vehicle, wherein
the situation determiner drives the fuel lid to open the fuel hole when both of an open condition that the opening of the fuel lid is determined to be permissible with a detected condition of the fuel hole being in the close condition and a switch condition that the trigger switch is operated are respectively fulfilled as prerequisites.

9. The fuel lid driving apparatus of claim 7 further comprising:
a wireless key system is disposed in the vehicle;
a radio wave transmitter for transmitting a key polling wave in a polling area that exists at a proximity of the fuel lid is provided in the vehicle;
a key detector for detecting a wireless key in the polling area based on response information is provided in the vehicle;
the situation determiner performs a determination when both of a first condition that the fuel lid is open and a second condition that the wireless key is not detected in the polling area are respectively fulfilled as prerequisites;
an information receiver for receiving authentication information from the wireless key in the polling area; and
an authentication unit for authenticating the wireless key based on the received authentication information, wherein
the open situation determiner determines that the opening of the fuel lid is permissible when both of two prerequisites that a detected fuel hole condition is closed and that the wireless key is detected and authenticated in the polling area are fulfilled.

10. The fuel lid driving apparatus of claim 7, wherein
a vehicle navigation system is provided in the vehicle, and
the open situation determiner determines that the opening of the fuel lid is permissible when a prerequisite that a current position of the vehicle detected by the vehicle navigation system is a gas supply facility is fulfilled.
